(19) United States
(12) Patent Application Publication
(10) Pub. No.: US 2011/0219310 A1
(43) Pub. Date: Sep. 8, 2011

(54) System, Method and Computer Program Product for a Dating Decision Process

(75) Inventor: Kurt Gregory Robson, Foster City, CA (US)

(73) Assignee: KR Global Development LLC, Foster City, CA (US)

(21) Appl. No.: 13/038,250

(22) Filed: Mar. 1, 2011

Related U.S. Application Data
(60) Provisional application No. 61/310,242, filed on Mar. 3, 2010.

(51) Int. Cl. G06F 3/01

(52) U.S. Cl. 715/733

(57) ABSTRACT

A system and method include establishing a first member profile and displaying a second member profile. The first member is restricted from viewing portions of the second member profile. A level of interest the first member has for a second member is indicated in the second member profile and the server restricts the second member from viewing the indication. The first member is notified that the level of interest the first member has for the second member matches a second member's selected level of interest for the first member and the second member is notified of the matching. The first member views at least a portion of the portions that were restricted, the matching interest level and the list of pre-defined stages available for further selection and matching. The first member is enabled to contact the second member in response to the matching interest level corresponding to a desire to meet.

### CROSS-REFERENCE TO RELATED APPLICATIONS

The present Utility patent application claims priority benefit of the U.S. provisional application for patent Ser. No. 61/310,242 filed on Mar. 3, 2010 under 35 U.S.C. 119(e). The contents of this related provisional application are incorporated herein by reference for all purposes to the extent that such subject matter is not inconsistent herewith or limiting hereof.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to electronic dating. More particularly, the invention relates to electronic dating and matching techniques in a computer based social networking or electronic dating service.

### BACKGROUND OF THE INVENTION

Electronic dating and matchmaking systems suffer from several problems which prevent many potentially compatible members from ever meeting or establishing any sort of relationship. One such problem is fear of rejection, which may cause both parties to be unwilling to initiate contact with another member through a phone call or email. Many people, especially women, feel uncomfortable making the first move, even if that move is to simply show the slightest interest. For example, some woman feel it is a matter of pride to never initiate any communication with a man to pursue a date, and this problem is not limited to the initial contact. Even after an initial meeting, both parties may be too nervous to write a message proposing to meet again for a more intimate encounter, or any sort of second date. As such, both parties often procrastinate, maybe indefinitely.

Another problem with current electronic dating and matchmaking is that time lags and unanswered messages may prevent potentially compatible members from connecting. A popular member may get so many messages that they may not have time to answer them all or may take so long to answer that the other member gets the feeling that the popular member is not being responsive enough. Fickleness and indecisiveness can also lead to many potential matches being unfulfilled. For example, a woman might review several profiles and feel interested to know more about a particular member yet not do anything about it. Later, this member writes a message to the woman suggesting some contact; however, the woman has changed her mind or forgotten that she once had some interest in the member.

Another problem that exists with online dating services is the inability to charge for the service in a way directly related to value received. The best way to charge for a service is to charge for results, thus eliminating any risk to the customer for paying without receiving results. However, once members connect for the first time in a typical online dating service, there is little chance of systematically determining if the relationship has progressed to some level of “dating fulfillment” or not to be able to use such information to charge a fee for actual results.

In view of the foregoing, there is a need for improved techniques for providing effective electronic dating systems that are able to charge based on results.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a flowchart illustrating an exemplary method for providing matches in a multiple stage, mutual interest electronic dating system, in accordance with an embodiment of the present invention;

FIG. 2 is a flowchart illustrating an exemplary interaction between two members of an exemplary multiple stage, mutual interest electronic dating system, in accordance with an embodiment of the present invention;

FIG. 3 is a screen shot of an exemplary member profile page in a multiple stage, mutual interest electronic dating system on a PC, in accordance with an embodiment of the present invention;

FIG. 4 is a screen shot of a member profile link in a multiple stage, mutual interest electronic dating system on an SMS enabled Smartphone, in accordance with an embodiment of the present invention;

FIG. 5 is a screen shot of an event attendee list from a multiple stage, mutual interest electronic dating system, in accordance with an embodiment of the present invention; and

FIG. 6 illustrates a typical computer system that, when appropriately configured or designed, can serve as a computer system in which the invention may be embodied.

Unless otherwise indicated illustrations in the figures are not necessarily drawn to scale.

### SUMMARY OF THE INVENTION

To achieve the forgoing and other objects and in accordance with the purpose of the invention, a system, method and computer program product for a dating decision process is presented.

In one embodiment a system includes means for a first member to establish a first member profile on a server, means for a second member to establish a second member profile on the server, means for the first member to display the second member profile where the server restricts the first member from viewing portions of the second member profile, means for the second member to display the first member profile where the server restricts the second member from viewing portions of the first member profile, means for the first member to indicate to the server at least one level of interest the first member has for the second member, the level of interest being indicated in the second member profile and the server restricting the second member from viewing the indication, means for the second member to indicate to the server at least one level of interest the second member has for the first member, the level of interest being indicated in the first member profile and the server restricting the first member from viewing the indication, means for notifying the first member of the at least one level of interest the first member has for the second member matching the at least one level of interest the second member has for the first member and enabling the first member to view at least a portion of the portions of the second member profile that were restricted, and means for notifying the second member of the at least one level of interest the second member has for the first member matching the at least one level of interest the first member has for the second member enabling the second member to view at least a portion of the portions of the first member profile that were restricted. In another embodiment the first member profile includes a profile photo, general information, information about appearance, sexual orientation, private photos and contact information. In yet another embodiment the second member profile includes a profile photo, general information, information about appearance, sexual orientation, private photos and contact information. In still another embodiment the at least one level of interest being selected from a list of pre-defined stages of a dating decision process, the list of pre-defined stages being presented in an order of progressively higher levels of interest. In another embodiment the means for notifying the first member further enables the first member to view the at least one matching interest level and the list of pre-defined stages available for further selection and matching. In yet another embodiment the means for notifying the second member further enables the second member to view the at least one matching interest level and the list of pre-defined stages available for further selection and matching. Still another embodiment further includes means for the first member and the second member to connect in response to the at least one matching interest level corresponding to a desire to connect. Another embodiment further includes means for enabling the first member and the second member to directly contact each other in response to the at least one matching interest level corresponding to a desire to meet. Yet another embodiment further includes means for billing when the first member and the second member reach a determined matching interest level. In still another embodiment the portions that were restricted include private photos and contact information.

In another embodiment a method includes the steps of a client establishing, on a server, a first member profile input by a first member for the first member. The first member profile includes a profile photo, general information, information about appearance, sexual orientation, private photos and contact information. The client displays for the first member a second member profile established on the server by a second member for the second member. The second member profile includes a profile photo, general information, information about appearance, sexual orientation, private photos, and contact information. The server restricts the first member from viewing portions of the second member profile. The client indicates to the server at least one level of interest the first member has for the second member. The level of interest is indicated in the second member profile and the server restricts the second member from viewing the indication. The level of interest is selected from a list of pre-defined stages of a dating decision process. The client presents the list of pre-defined stages in an order of progressively higher levels of interest. The client receives notification from the server to the first member of the at least one level of interest the first member has for the second member matching a second member's at least one selected level of interest for the first member and the server sending notification to the second member of the matching. The second member's at least one selected level of interest is indicated in the first member profile and is restricted from being viewed by the first member. The client receives with the notification a link to the second member profile. The client displays for the first member the linked to second member profile with the server enabling the first member to view at least a portion of the portions that were restricted, the at least one matching interest level and the list of pre-defined stages available for further selection and matching. The client receives, from the server, means for the first member to connect with the second member in response to the at least one matching interest level corresponding to a desire to connect. The client receives, from the server, contact information enabling the first member to contact the second member in response to the at least one matching interest level corresponding to a desire to meet where the server bills the first member at reaching this matching interest level. In another embodiment the portions that were restricted include private photos and contact information. In yet another embodiment the client comprises a mobile communication device. Still another embodiment further includes the client displaying for the first member a plurality of member profiles for members attending an event at which the first member is attending. Another embodiment further includes the client indicating to the server at least one level of interest the first member has for one or more of the plurality of members.

In another embodiment a non-transitory program storage device readable by a machine tangibly embodying a program of instructions executable by the machine to perform a method for a dating decision process, includes computer code for a client to establish, on a server, a first member profile input by a first member for the first member. The first member profile includes a profile photo, general information, information about appearance, sexual orientation, private photos and contact information. Included is computer code for the client to display for the first member a second member profile established on the server by a second member for the second member. The second member profile includes a profile photo, general information, information about appearance, sexual orientation, private photos and contact information. The server restricts the first member from viewing portions of the second member profile. Included is computer code for the client to indicate to the server at least one level of interest the first member has for the second member. The level of interest is indicated in the second member profile and the server restricts the second member from viewing the indication. The level of interest is selected from a list of pre-defined stages of a dating decision process. The client presents the list of pre-defined stages in an order of progressively higher levels of interest. Included is computer code for the client to receive notification from the server to the first member of the at least one level of interest the first member has for the second member matching a second member's at least one selected level of interest for the first member and the server sending notification to the second member of the matching. The second member's at least one selected level of interest is indicated in the first member profile and restricted from being viewed by the first member. Included is computer code for the client to receive with the notification a link to the second member profile. Included is computer code for the client to display for the first member the linked to second member profile with the server enabling the first member to view at least a portion of the portions that were restricted, the at least one matching interest level and the list of pre-defined stages available for further selection and matching. Included is computer code for the client to receive, from the server, means for the first member to connect with the second member in response to the at least one matching interest level corresponding to a desire to connect. Included is computer code for the client to receive, from the server, contact information enabling the first member to contact the second member in response to the at least one matching interest level corresponding to a desire to meet where the server bills the first member at reaching this matching interest level. In another embodiment the portions that were restricted include private photos and contact information. In yet another embodiment the client comprises a mobile communication device. Still another embodiment further includes computer code for the client to display for the first member a plurality of member profiles for members attending an event at which the first member is attending. Another embodiment further includes computer code for the client to indicate to the server at least one level of interest the first member has for one or more of the plurality of members.

Other features, advantages, and objects of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

“Software” may refer to prescribed rules to operate a computer. Examples of software may include: code segments in one or more computer-readable languages; graphical and or/textual instructions; applets; pre-compiled code; interpreted code; compiled code; and computer programs.

A “computer-readable medium” may refer to any storage device used for storing data accessible by a computer. Examples of a computer-readable medium may include: a magnetic hard disk; a floppy disk; an optical disk, such as a CD-ROM and a DVD; a magnetic tape; a flash memory; a memory chip; and/or other types of media that can store machine-readable instructions thereon.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

A preferred embodiment of the present invention and at least one variation thereof provide a method and system based on using mutual interest matches at each of multiple stages in the dating process to help members in a social network or electronic dating service more quickly and frequently reach their dating objective while also enabling the service to charge members based on events more closely related to the dating objective. A “dating objective” is herein defined as the goal of establishing some relationship with another member, including, but not limited to, a one time sexual encounter, a “just friends” relationship, a long-term romance, a marriage, etc.

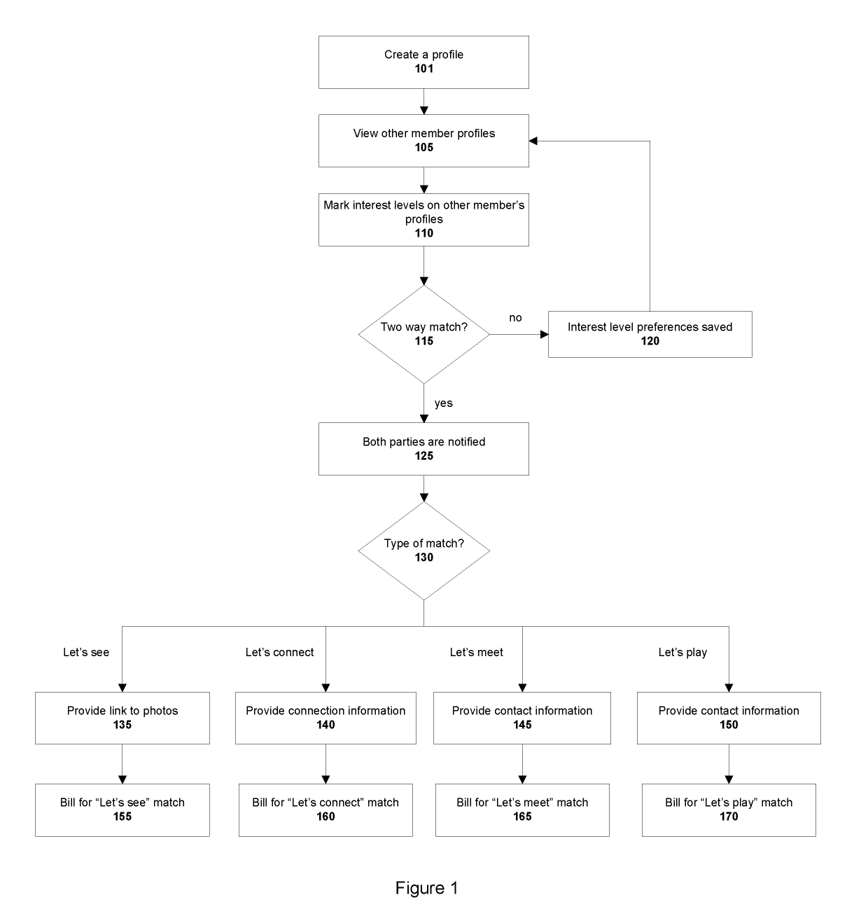

FIG. 1 is a flowchart illustrating an exemplary method for providing matches in a multiple stage, mutual interest electronic dating system, in accordance with an embodiment of the present invention. In the present embodiment, members of a social network or dating site are able to privately indicate whether they wish to proceed to each of multiple pre-defined stages of the dating decision process with another member. Each stage represents a progressively higher level of interest that typically occurs through the process of establishing a relationship. In the present embodiment, the dating process is broken into the following interest level stages, “Let's See”, “Let's Connect”, “Let's Meet”, and “Let's Play” indicating an interest to see more photos, talk by phone, have an initial meeting or meet again, and have sex, respectively. In alternate embodiments the process may be broken into fewer, more or different interest levels.

The present embodiment is preferably implemented in a multiplicity of different dating sites where most members of each site have the same objective in mind. However, there is a high degree of overlap in these dating sites. For example, without limitation, many members of sexual dating sites are also members of romance dating sites and would be happy to achieve “the wrong objective” on either site. Further, a mutual interest in having sex is certainly a key step along the way to a long-term relationship for many people. Therefore, some alternate embodiments of the present invention may be implemented as a single dating site where the members have different dating objectives in mind. A difference in application of some of these alternate embodiments is which interest levels are included and also how these interest levels are labeled. For example, without limitation, the interest level for having sex might be called “lets play” in one embodiment and “let's get physical” in another embodiment. Also, when applied to dating sites where having sex is not typically an objective, for example, without limitation, religious dating sites, this interest level may be omitted or replaced by a different interest level such as, but not limited to, “lets confess”, “let's go to church” or “let's pray”. Those skilled in the art, in light of the present teachings, will readily recognize that a multiplicity of suitable interest levels may be included in alternate embodiments of the present invention such as, but not limited to, “let's see your profile” to view a member's profile beyond general information, “let's see your more revealing photos”, “let's message” to connect without revealing email addresses, “let's email”, “let's chat in a private chat room”, “let's text without revealing phone numbers” (requires text server), “let's talk by phone without revealing phone numbers” (requires telephone solution), “let's text directly revealing phone numbers”, “let's talk directly revealing phone numbers”, “let's meet again”, “let's have a 3rd date”, “let's get married”, etc. Alternate embodiments may comprise any number of interest settings, beginning with an embodiment with a single interest setting; however too many settings may be too complicated to use and may not achieve optimal value to the user. Furthermore, since many preferred embodiments of the present invention are meant to perform mutual interest matching at multiple interest levels, it is preferrable that two or more interest levels are included in these embodiments.

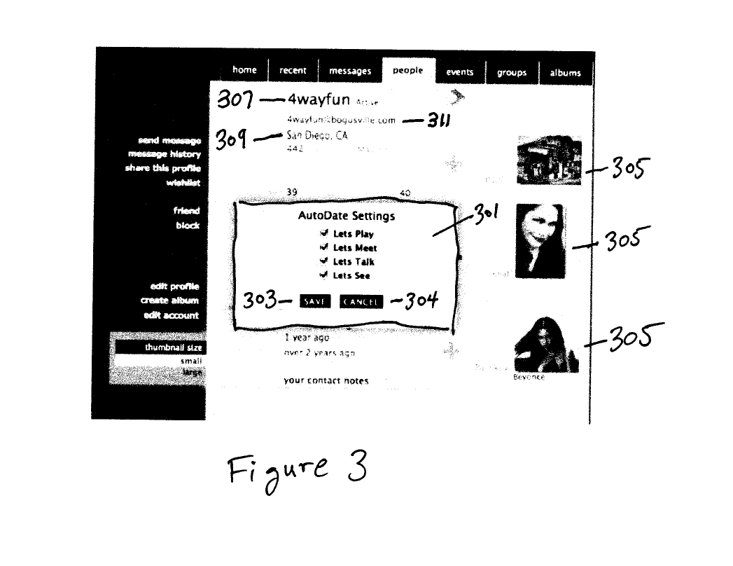

In typical use of the present embodiment, a user accesses the dating system through a social network or dating web site on a desktop computer, a laptop, or mobile device such as, but not limited to, a Smartphone or a tablet computer. To begin using the electronic dating system, the user first creates a profile with the system in step 101. This profile may comprise a wide variety of information including, but not limited to, a profile photo, general information, information about appearance, sexual orientation, private photos, contact information, interests, location, age, drinking/smoking levels, favorite websites, etc. Once the user is a member of the system, he may browse the profiles of other members in step 105. The profile information visible to members who are merely browsing the system is preferably limited to protect the privacy of the members. For example, without limitation, profile information visible to all members may include, without limitation, a profile photo, sexual orientation, general information such as, but not limited to gender and age, information about appearance such as, but not limited to, height, weight, hair color, eye color, etc. Once the user finds another member in which he is interested, he can indicate his interest in pursuing each stage of the dating decision process with this member by marking the corresponding interest levels on this member's profile in step 110. In the present embodiment, members are not informed of other member's interest in their profile unless the interest is mutual. This differs from some currently known matching sites that enable an indication of interest to be revealed to the other member without a match. In step 115, the system determines if there is a mutual interest match at a particular interest level between the user and the member. A mutual interest in this case refers to the members being mutually interested in taking an action with each other such as, but not limited to, talking or meeting, as opposed to “a mutual interest in kite surfing” for example, without limitation, which is also different from many currently known matching sites that find compatibility matches based on common interests. Instead, the present embodiment uses interest level settings about another member that relate to moving further toward the overall dating objective with that member. If there is no mutual interest match in the present embodiment, the interest level preferences for the user and this member are saved by the system in step 120, and the user is able to return to step 105 to view more member profiles. In the present embodiment, as shown by way of example in FIG. 3, the user can return to other members' profiles to view and modify the current interest settings at any time.

Referring to FIG. 1, in the present embodiment when a mutual interest match occurs at a particular stage in step 115, both parties are notified in step 125. This mutual interest match may be made immediately when the user indicates his interest level preferences or may occur later when the member in which he has indicated interest views the profile of the user and selects the same interest level. Since the match occurs when the second party marks their interest at a particular interest level, the system notifies the second party immediately on their computer screen or mobile device screen. A message such as but not limited to, an electronic message, email or SMS text message if a phone number of a SMS enabled device is provided to the system is sent to the first party. In an alternate embodiment a notification message may be sent to the second party rather than an immediate alert. In the present embodiment, the mutual interest notification alerts and messages may comprise direct links to the members' profiles such that, when clicked, the members are navigated directly to the other member's profile page. Where appropriate, the activity of the particular stage of the dating decision process indicated by the matched interest level is automatically facilitated. For example, without limitation, the members may be able to view each other's private not otherwise visible photos or a phone call or SMS text message on a mobile phone or through a computer may be initiated.

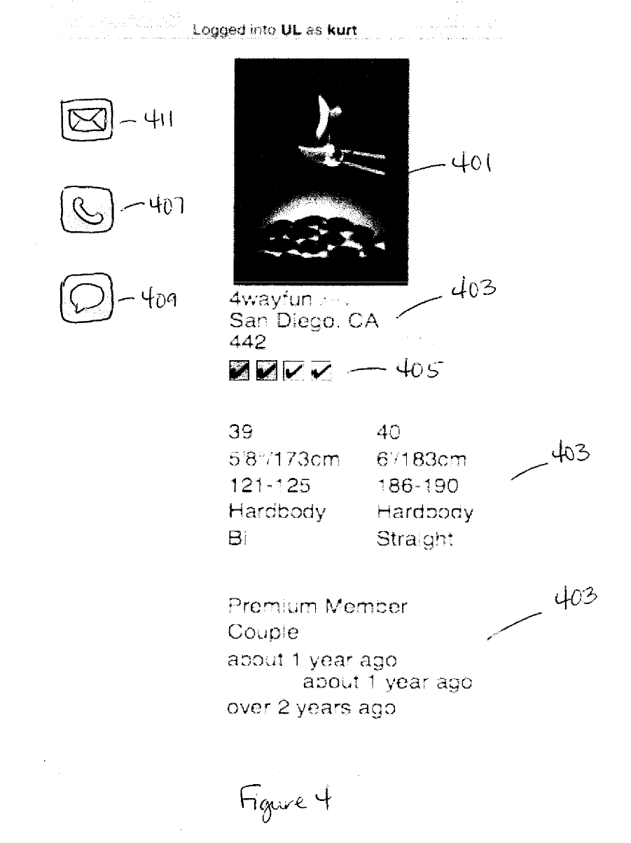

In step 130, the system determines what type of mutual match has been made. For a stage where members indicate mutual interest in seeing each other's private photos, a “Let's See” match in the present embodiment, the system activates a link for each member that, when pressed, automatically provides a view of all of the photos of the other member including private, not otherwise visible photos in step 135. Once two members have agreed that they have a mutual attraction based on appearance, the typical next stage is to talk to the member to check chemistry. If the mutual match is at the “Let's Connect” interest level, the system provides connection information or a link enabling the members to connect in step 140. Such connection information may include, without limitation, an email address, an instant messaging account, a link to a private chat room, a phone number, etc. In general, members in a social network or dating site do not publish their phone numbers on their member profile. Therefore, agreeing to have a phone conversation often requires one party to “go out on a limb” and offer their phone number first, hoping that the other party is indeed interested to talk. Using the present embodiment, this type of information is only provided if a mutual interest match occurs. Furthermore, on a smart phone, a Call or SMS button may be included in the profile page links, as shown by way of example in FIG. 4, which, when pressed, automatically initiates a phone call or SMS text message, with or without revealing the members' phone numbers. Many interest level settings may tie directly to different forms of contact. Since the interest levels representing different stages in dating typically represent different forms of contact, members can control exactly who may contact them in each of multiple ways in many preferred embodiments. For example, without limitation, a “Let's Email” match, which may be provided in some alternate embodiments, could cause each other's email address to be revealed, or such a match may facilitate a PC or Smartphone based message button for composing an email, which is not available without a mutual match at this level. A mutual match at a “let's talk by phone” interest level that may be available in some alternate embodiments could reveal phone numbers or facilitate a call button on a Smartphone. Similarly a “let's text” match could reveal phone numbers or facilitate a Text or SMS button on a Smartphone, and so on.

Once both members are satisfied with appearance and chemistry, they may wish to meet in person to see if they wish to pursue a relationship or sexual encounter. Again, rather than one party needing to go “out on a limb” to suggest a meeting, both parties may simply mark (or not) the “Let's Meet” setting on the other member's profile. If a mutual interest match occurs at the “Let's Meet” interest level, contact information is provided to both parties in step 145 to enable the members to arrange a meeting. In the present embodiment, the final interest level is the “Let's Play” level indicating interest in a sexual encounter. This level suffers the most from the fear of rejection problem encountered with traditional dating techniques. In the present embodiment, both parties may check the “Let's Play” interest level on the other member's profile, without concern that the other member will know about their interest, unless the interest is mutual. If a “Let's Play” match occurs, both parties are provided with the other's contact information in step 150 so that they may arrange their encounter. As part of the contact information provided in steps 145 and 150, a “Let's Meet” or “Let's Play” match could facilitate links to a calendar system or an auto-scheduling function if applicable to the two parties. Further, a “Let's Meet” or “Let's Play” match could reveal more precise physical locations of both members than is provided in the members' profile. Those skilled in the art, in light of the present teachings, will readily recognize that alternate embodiments of the present invention may be implemented to provide various different types of information, links and buttons with match notifications. For example, without limitation, some alternate embodiments may not comprise links or buttons for facilitating actions relating to the matched interest level. It is also possible within this invention for members to set privacy controls to govern how certain mutual interest matches might be facilitated. For example, a very popular female may indicate that Let's Connect matches may email her, or text her through an anonymous emailing or texting mechanism (one that does not reveal her email address or phone number), while other members may allow Let's Connect matches to text or email directly, revealing their email address and/or cell phone number.

In the present embodiment, members may mark interest on any subset of interest levels and each interest level may be checked individually and does not automatically imply that all “lower levels” are checked. A non-limiting example is a couple that talks on the phone, after which one party decides they want to meet while the other wants to talk on the phone more. However, if the party who wishes to meet does not want to spend more time talking on the phone, this party can remove the “Let's Connect” setting and leave the “Let's Meet” setting. In some alternate embodiments, the selection of a “higher interest level” may require that all of the “lower levels” are also selected.

By breaking the dating process down into stages related to progressively higher interest levels and detecting mutual interest matches, the present embodiment enables the service provider to charge a fee to members based on finding matches at higher interest levels. Since the system has a record of later stage matches, it is possible to bill members only when they come close to reaching their “dating objective” or bill members more for these later stage matches. A member who hopes to find a partner for a sexual encounter or long term romantic relationship would generally prefer to pay for results rather than pay a monthly fee. In steps 155 through 170 the members are charged according to the mutual matches made through the system. The amount charged for each type of match preferably increases as the interest level increases. Therefore a “Let's Meet” match, billed in step 165, preferably costs more than a “Let's See” match, billed in step 155 or a “Let's Connect” match, billed in step 160, and the system charges the highest amount for a “Let's Play” match, billed in step 170. In some alternate embodiments, there may be no charges for lower level matches such as, but not limited to, “Let's See” matches or “Let's Connect” matches. Furthermore, in some alternate embodiments the billing system may be set up such that only men pay for matches and women can use the system at no charge. Yet other alternate embodiments may be implemented as free services. In the sexual dating world, a mutual interest match for having sex enables the service to charge directly for something very close to the objective. Some percent of such mutual interest matches are not fulfilled; however, a “Let's Play” match is a much closer proxy to the actual objective of the member than simply being an active member of the service for some period. In a romantic dating environment, the system could charge for second date or “Let's Meet Again” matches.

The system according to the present embodiment may allow more members to achieve their dating object than they would with traditional methods by enabling members to express interest, without fear of rejection, and letting the system identify and notify members of matches. The present embodiment addresses the problem of overflowing email queues, and email response delays, by not requiring any messages to be responded to or sent. Once a mutual interest match occurs, both parties are immediately notified, and thereby neither party is required to respond in any particular timeframe to confirm the interest. When a “Let's See” match occurs, no further communication is required to review each other's private photos. When a “Let's Talk” match occurs, no further communication is required to exchange phone numbers as they are revealed automatically or revealed when pressing the Call or SMS buttons. The present embodiment addresses the problem of fickleness and indecisiveness by virtue of members being forced to decide if they have an interest or not, and if so, once they have indicated interest for a particular interest level with another member, there is an expectation that if a match occurs, they must indeed follow through. An alternate embodiment of the present invention comprises a feedback mechanism to expose members who regularly indicate interest and do not follow through when a match occurs. The capabilities of the present embodiment not only improve the effectiveness of an electronic dating service; they also provide a scheme for billing members based on value received. By both providing a more effective service, and charging purely for the value, a social networking or electronic dating system according to the present embodiment can become substantially more effective and profitable than traditional methods.

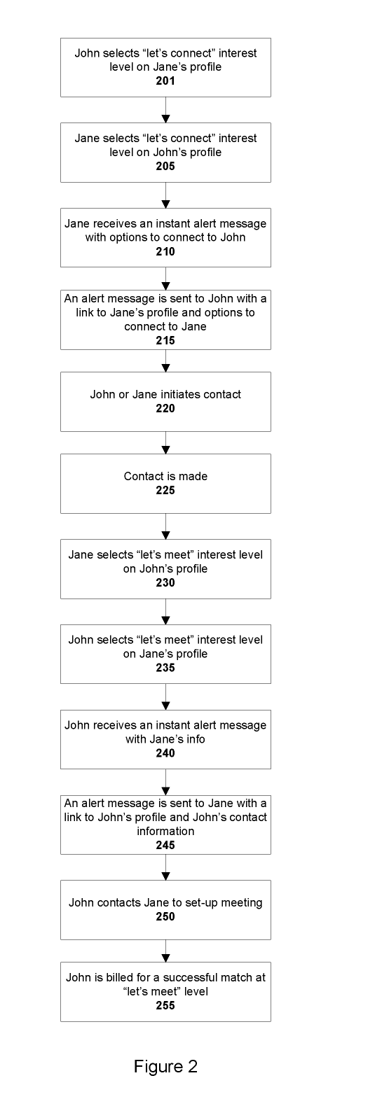

FIG. 2 is a flowchart illustrating an exemplary interaction between two members, John and Jane, of an exemplary multiple stage, mutual interest electronic dating system, in accordance with an embodiment of the present invention. In the present embodiment, the system comprises two interest levels, a “Let's Connect” interest level which means that a member would like to communicate by email, phone, or text, and a “Let's Meet” interest level which means that a member is interested in a physical meeting. In step 201 John marks the “Let's Connect” interest level on Jane's profile. Sometime later while reviewing all single males, Jane marks the “Let's Connect” interest level on John's profile in step 205. Jane immediatly receives an alert message of the match in step 210, for example, without limitation “You found a match!”, along with phone, text, and email buttons if Jane is using the system on a telephone and SMS enabled device. John receives an email and a text indicating that a “Let's Connect” match has been made with Jane in step 215. The text and email include, without limitation, a link to Jane's profile to enable John to refresh his memory of Jane, a phone button, an email button and a text button are also included if John is using a telephone and SMS enabled device. In step 220 John or Jane initiates contact, for example, without limitation, by clicking the phone button. In step 225 contact is made, and John and Jane are able to talk. Both understand the dating system, so neither try to “close the deal” and ask for an in person date. Jane updates the interest level settings on John in step 230 by checking the “Lets Meet” interest level on John's profile. John later updates the interest level settings on Jane's profile in step 235 by also checking the “Let's Meet” interest level. In step 240 John receives an immediate alert message along with Jane's contact information. Jane receives email and text notification of the match with links to John's profile and contact information in step 245. John contacts Jane in step 250, for example, without limitation, by sending a text message to Jane and setting up a meeting. In step 255, the dating site bills John for finding a “Let's Meet” match. In the present example, ladies are able to match all they want for free.

An alternate embodiment of the present invention provides a multiple stage, mutual interest electronic dating system in a sexual dating environment where members are trying to find a partner for a sexual encounter. In a social network where members may view profiles of other members and perform searches based on member profile attributes, members can easily find other members in whom they might have an interest. However, in many cases due to privacy concerns, the photos visible to all members are limited, and often do not include facial photos. So it is quite common that a member wishes to see more revealing photos of the other member, before knowing if they are interested. As such, the present embodiment enables a user to mark a “Let's See” interest level for another member. If both members have marked this interest level, the system automatically allows otherwise restricted photos of these members to be visible to both parties. By identifying the mutual interest stages in a sexual dating process and applying the system to sites focused on the sexual dating process, the present embodiment is applied in an environment where the better it works, the more members use it. Consider this in contrast to a long-term relationship dating site where the better it works, the sooner members no longer need it. It is contemplated that within the sexual dating environment, there are a multiplicity of suitable ways to apply the dating system and a multiplicity of suitable interest levels on which to match. For example, without limitation, within the kink/bdsm world, the “Let's Have Sex” interest level may need to be much more specific and include different types of sex. In a sexual dating environment, charging for “Let's Play” matches may be a very effective way to charge a fee for each sex partner a member finds, and many members prefer to pay for the service on this basis over a simple monthly fee.

FIG. 3 is a screen shot of an exemplary member profile page in a multiple stage, mutual interest electronic dating system on a PC, in accordance with an embodiment of the present invention. In the present embodiment, a user can select interest level settings 301 of this member on the profile page and save interest level settings 301 using a save button 303 or cancel settings 301 with a cancel button 304. The user can view and modify interest settings 301 at any time. The profile page also comprises information about the member such as, but not limited to, profile pictures 305 a user name 307, a current city 309, etc. Those skilled in the art, in light of the present teachings, will readily recognize that a multiplicity of suitable items may be included on a member's profile page including, but not limited to, age, sexual orientation, religious and political views, height, education, employment, etc. In the present example, a mutual match at the “Let's Talk” interest level has been made; therefore, an email address 311 is also shown.

FIG. 4 is a screen shot of a member profile link in a multiple stage, mutual interest electronic dating system on an SMS enabled Smartphone, in accordance with an embodiment of the present invention. In the present embodiment, the link is typically sent to a user in an alert message notifying the user of a mutual match. The link comprises a profile picture 401 and general information about the member 403 to refresh the user's memory of the member. Interest level settings 405 are also shown. Interest level settings 405 where mutual interest matches exist are highlighted to clearly communicate to the user which settings are a match. Alternate embodiments may not highlight mutual interest matches in the interest level settings. In the present embodiment, a mutual interest match has been made to connect. Therefore, a phone call button 407 is provided to initiate a phone call, an SMS button 409 is provided to initiate an SMS text message, and an email button 411 is provided to compose an email. Any device capable of both displaying a mutual interest notification or member profile and also capable of initiating a phone call, email or instant message preferably includes the relevant links or buttons to perform such actions. However, these buttons may not be included in alternate embodiments. In other alternate embodiments, these buttons may be displayed in various different locations within the system for example, without limitation, on members' profile pages.

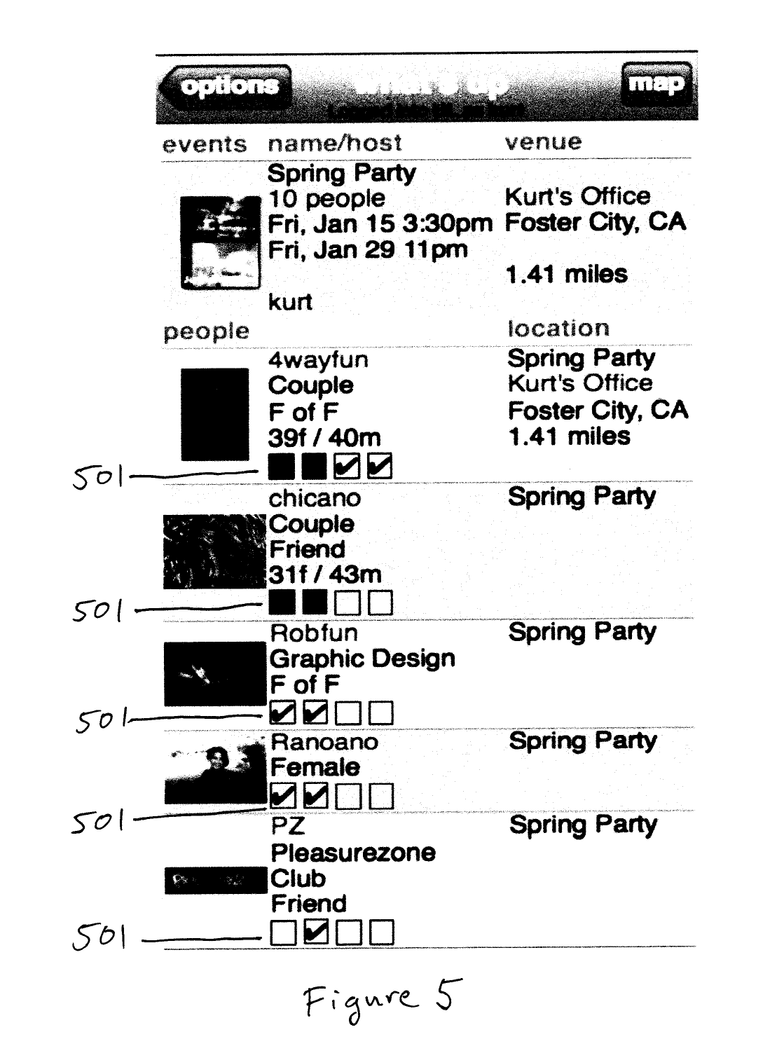

FIG. 5 is a screen shot of an event attendee list from a multiple stage, mutual interest electronic dating system, in accordance with an embodiment of the present invention. In the present embodiment, the dating system is being used in the context of an event, where a group of members attending the event are using the system on Smartphones. A user may peruse the list of event attendees prior to the event from a Smartphone or desktop device and set interest level settings 501 for the other attendees. The list also indicates where mutual interest setting matches have been made by highlighting these matches. At the event, each member with a Smartphone can, as they meet and gain more information about other members, continually review the list of members, update settings, and potentially create and receive notification of new matches. Since the present embodiment also preferably includes the ability to send a text notification when new matches have occurred, during the event, the user's phone can signal the user each time a new match occurs. Therefore, if during the event, a member for whom the user had previously selected the “Let's Meet” or “Let's Play” interest level, newly selects the same interest level for the user, that member immediately receives an alert message of a found match on their screen, and the user immediately receives an SMS text message about the new match, including appropriate links to see the other member's profile and Call or SMS buttons to facilitate communication. The present embodiment is preferably used in conjunction with a particular event where the use of the system has been promoted among the attendees. In an event where many people are looking to “hook up” for example, without limitation, a singles nightclub event or a speed dating event with the dynamic of time remaining winding down and alcohol content ramping up, many new matches will typically occur as the event progresses, potentially causing a huge buzz around the event. Even before the event, as members review profiles and mark interest settings, the system may well cause a buzz around the event as members invite others or decide to attend based on matches with other members who are also attending.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

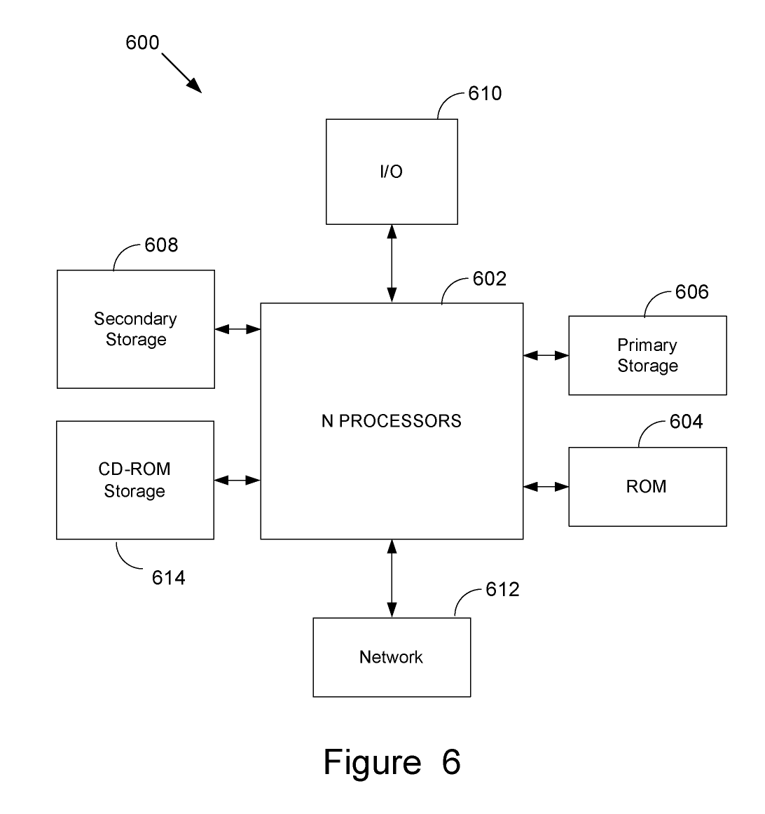

FIG. 6 illustrates a typical computer system that, when appropriately configured or designed, can serve as a computer system in which the invention may be embodied. The computer system 600 includes any number of processors 602 (also referred to as central processing units, or CPUs) that are coupled to storage devices including primary storage 606 (typically a random access memory, or RAM), primary storage 604 (typically a read only memory, or ROM). CPU 602 may be of various types including microcontrollers (e.g., with embedded RAM/ROM) and microprocessors such as programmable devices (e.g., RISC or SISC based, or CPLDs and FPGAs) and unprogrammable devices such as gate array ASICs or general purpose microprocessors. As is well known in the art, primary storage 604 acts to transfer data and instructions uni-directionally to the CPU and primary storage 606 is used typically to transfer data and instructions in a bi-directional manner. Both of these primary storage devices may include any suitable non-transitory computer-readable media such as those described above. A mass storage device 608 may also be coupled bi-directionally to CPU 602 and provides additional data storage capacity and may include any of the non-transitory computer-readable media described above. Mass storage device 608 may be used to store programs, data and the like and is typically a secondary storage medium such as a hard disk. It will be appreciated that the information retained within the mass storage device 608, may, in appropriate cases, be incorporated in standard fashion as part of primary storage 606 as virtual memory. A specific mass storage device such as a CD-ROM 614 may also pass data uni-directionally to the CPU.

CPU 602 may also be coupled to an interface 610 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 602 optionally may be coupled to an external device such as a database or a computer or telecommunications or internet network using an external connection as shown generally at 612, which may be implemented as a hardwired or wireless communications link using suitable conventional technologies. With such a connection, it is contemplated that the CPU might receive information from the network, or might output information to the network in the course of performing the method steps described in the teachings of the present invention.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC §112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC §112 (6).

It is noted that according to USA law, all claims must be set forth as a coherent, cooperating set of limitations that work in functional combination to achieve a useful result as a whole. Accordingly, for any claim having functional limitations interpreted under 35 USC §112 (6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC §112 (6) is/(are) dependent on one or more remote servers located outside the USA, it is intended that each such recited function under 35 USC §112 (6) is to be interpreted as the function of the local system receiving the remotely generated information required by a locally implemented claim limitation, wherein the structures and or steps which enable, and breath life into the expression of such functions claimed under 35 USC §112 (6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “35 USC §112 (6)” should be replaced with the closest corresponding statute in the patent laws of such pertinent country or countries or legal organization(s).

Having fully described at least one embodiment of the present invention, other equivalent or alternative methods of providing a multiple stage, mutual interest electronic matching system according to the present invention will be apparent to those skilled in the art. The invention has been described above by way of illustration, and the specific embodiments disclosed are not intended to limit the invention to the particular forms disclosed. For example, the particular implementation of the system may vary depending upon the particular type of environment in which it is to be used. The systems described in the foregoing were directed to dating implementations; however, similar techniques are to provide matching systems that may be used in various different environments for example, without limitation, general social networking, professional networking, job searching and hiring, recruiting for organizations such as, but not limited to fraternities, sororities, clubs, sports teams, etc. Non-dating implementations of the present invention are contemplated as within the scope of the present invention. The invention is thus to cover all modifications, equivalents, and alternatives falling within the spirit and scope of the following claims.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. A system comprising:
means for a first member to establish a first member profile on a server;
means for a second member to establish a second member profile on said server;
means for the first member to display said second member profile where said server restricts the first member from viewing portions of said second member profile;
means for the second member to display said first member profile where said server restricts the second member from viewing portions of said first member profile;
means for the first member to indicate to said server at least one level of interest the first member has for the second member, said level of interest being indicated in said second member profile and said server restricting the second member from viewing said indication;
means for the second member to indicate to said server at least one level of interest the second member has for the first member, said level of interest being indicated in said first member profile and said server restricting the first member from viewing said indication;
means for notifying the first member of said at least one level of interest the first member has for the second member matching said at least one level of interest the second member has for the first member and enabling the first member to view at least a portion of said portions of said second member profile that were restricted; and
means for notifying the second member of said at least one level of interest the second member has for the first member matching said at least one level of interest the first member has for the second member enabling the second member to view at least a portion of said portions of said first member profile that were restricted.

2. The system as recited in claim 1, in which said first member profile includes a profile photo, general information, information about appearance, sexual orientation, private photos and contact information.

3. The system as recited in claim 2, in which said second member profile includes a profile photo, general information, information about appearance, sexual orientation, private photos and contact information.

4. The system as recited in claim 1, in which said at least one level of interest being selected from a list of pre-defined stages of a dating decision process, said list of pre-defined stages being presented in an order of progressively higher levels of interest.

5. The system as recited in claim 4, in which said means for notifying the first member further enables the first member to view said at least one matching interest level and said list of pre-defined stages available for further selection and matching.

6. The system as recited in claim 4, in which said means for notifying the second member further enables the second member to view said at least one matching interest level and said list of pre-defined stages available for further selection and matching.

7. The system as recited in claim 1, further comprising means for the first member and the second member to connect in response to said at least one matching interest level corresponding to a desire to connect.

8. The system as recited in claim 1, further comprising means for enabling the first member and the second member to directly contact each other in response to said at least one matching interest level corresponding to a desire to meet.

9. The system as recited in claim 1, further comprising means for billing when the first member and the second member reach a determined matching interest level.

10. The system as recited in claim 3, in which said portions that were restricted include private photos and contact information.

11. A method comprising the steps of:
a client establishing, on a server, a first member profile input by a first member for the first member, said first member profile including a profile photo, general information, information about appearance, sexual orientation, private photos and contact information;
said client displaying for the first member a second member profile established on said server by a second member for the second member, said second member profile including a profile photo, general information, information about appearance, sexual orientation, private photos and contact information, said server restricting the first member from viewing portions of said second member profile;
said client indicating to said server at least one level of interest the first member has for the second member, said level of interest being indicated in said second member profile and said server restricting the second member from viewing said indication, said level of interest being selected from a list of pre-defined stages of a dating decision process, said client presenting said list of pre-defined stages in an order of progressively higher levels of interest;
said client receiving notification from said server to the first member of said at least one level of interest the first member has for the second member matching a second member's at least one selected level of interest for the first member and said server sending notification to the second member of said matching, said second member's at least one selected level of interest being indicated in said first member profile and restricted from being viewed by the first member;
said client receiving with said notification a link to said second member profile;
said client displaying for the first member said linked to second member profile with said server enabling the first member to view at least a portion of said portions that were restricted, said at least one matching interest level and said list of pre-defined stages available for further selection and matching;
said client receiving, from said server, means for the first member to connect with the second member in response to said at least one matching interest level corresponding to a desire to connect; and
said client receiving, from said server, contact information enabling the first member to contact the second member in response to said at least one matching interest level corresponding to a desire to meet where said server bills the first member at reaching this matching interest level.

12. The method as recited in claim 11, in which said portions that were restricted include private photos and contact information.

13. The method as recited in claim 11, in which said client comprises a mobile communication device.

14. The method as recited in claim 13, further comprising said client displaying for the first member a plurality of member profiles for members attending an event at which the first member is attending.

15. The method as recited in claim 14, further comprising said client indicating to said server at least one level of interest the first member has for one or more of said plurality of members.

16. A non-transitory program storage device readable by a machine tangibly embodying a program of instructions executable by the machine to perform a method for a dating decision process, comprising:
computer code for a client to establish, on a server, a first member profile input by a first member for the first member, said first member profile including a profile photo, general information, information about appearance, sexual orientation, private photos and contact information;
computer code for said client to display for the first member a second member profile established on said server by a second member for the second member, said second member profile including a profile photo, general information, information about appearance, sexual orientation, private photos, contact information and said server restricting the first member from viewing portions of said second member profile;
computer code for said client to indicate to said server at least one level of interest the first member has for the second member, said level of interest being indicated in said second member profile and said server restricting the second member from viewing said indication, said level of interest being selected from a list of pre-defined stages of a dating decision process, said client presenting said list of pre-defined stages in an order of progressively higher levels of interest;
computer code for said client to receive notification from said server to the first member of said at least one level of interest the first member has for the second member matching a second member's at least one selected level of interest for the first member and said server sending notification to the second member of said matching, said second member's at least one selected level of interest being indicated in said first member profile and restricted from being viewed by the first member;
computer code for said client to receive with said notification a link to said second member profile;
computer code for said client to display for the first member said linked to second member profile with said server enabling the first member to view at least a portion of said portions that were restricted, said at least one matching interest level and said list of pre-defined stages available for further selection and matching;
computer code for said client to receive, from said server, means for the first member to connect with the second member in response to said at least one matching interest level corresponding to a desire to connect; and
computer code for said client to receive, from said server, contact information enabling the first member to contact the second member in response to said at least one matching interest level corresponding to a desire to meet where said server bills the first member at reaching this matching interest level.

17. The non-transitory program storage device readable by a machine tangibly embodying a program of instructions executable by the machine to perform a method for a dating decision process as recited in claim 16, in which said portions that were restricted include private photos and contact information.

18. The non-transitory program storage device readable by a machine tangibly embodying a program of instructions executable by the machine to perform a method for a dating decision process as recited in claim 16, in which said client comprises a mobile communication device.

19. The non-transitory program storage device readable by a machine tangibly embodying a program of instructions executable by the machine to perform a method for a dating decision process as recited in claim 18, further comprising computer code for said client to display for the first member a plurality of member profiles for members attending an event at which the first member is attending.

20. The non-transitory program storage device readable by a machine tangibly embodying a program of instructions executable by the machine to perform a method for a dating decision process as recited in claim 19, further comprising computer code for said client to indicate to said server at least one level of interest the first member has for one or more of said plurality of members.
